(19) United States
(12) Patent Application Publication
(10) Pub. No.: US 2003/0034410 A1
(43) Pub. Date: Feb. 20, 2003

(54) Document shredder for cutting flat material

(76) Inventor: J. Larry Wilkins, Sanford, NC (US)

Correspondence Address: J. Rodman Steele, Jr., Akerman, Senterfitt & Eidson, P.A., Post Office Box 3188, West Palm Beach, FL, 33402-3188, US

(21) Appl. No.: 09/933,450

(22) Filed: Aug. 20, 2001

(51) Int. Cl. B02C 18/06

(52) U.S. Cl. 241/143; 241/236

(57) ABSTRACT

A document shredder can be equipped with a shredding system for very high security. The shredding system can be made up of a first cutting stage with two corresponding cutting cylinders. After the first cutting stage a second cutting stage is provided for material cut in the first cutting stage. The second cutting stage can be made up of another pair of cutting cylinders. Alternatively, the second cutting stage can be made up of a third cutting cylinder reaching into one of the cutting cylinders of the first cutting stage, thereby establishing the second cutting stage.

The invention relates to a document shredder for cutting flat material into small particles with several cutting means, said cutting means forming cutting stages.

Document shredders are used for cutting paper of documents of confidential character. As such, the cutting should be of a kind for the documents to be illegible after cutting so the documents can not be read and their contents disclosed to anybody. Usually a document shredder has two cutting means in form of cutting cylinders. A cutting way for the paper or flat material to be cut leads through the cutting means or the two cutting cylinders, respectively.

The object of the invention is to provide a document shredder with improved shredding and higher security wherein the construction is simplified and effort is reduced.

According to the invention a document shredder is provided with the characteristics of claim 1. Further features of the invention can be gathered from the claims and are described hereinafter. By explicit reference the claims are incorporated into the description.

According to the invention there are provided at least two cutting stages, namely a first and a second cutting stage. As such, the flat material is shredded twice and the shredding can be done much finer. One cutting means of the first cutting stage can advantageously be a part of the second cutting stage, especially a functionally important part. As such, this cutting means is provided with a double function. It can replace the need for further cutting means of the second cutting stage. In other words the invention according to one embodiment can save the effort of one cutting means while providing two cutting stages.

Another important advantage is that with the invention it is possible to place the cutting means or cutting stages very close to each other. This provides the possibility for designing a smaller document shredder.

It is preferred to use cutting cylinders with a cutter profile as cutting means. Such cutting cylinders are well known in the art and as such do not need to be described.

It is possible to mesh the cutting cylinders of each cutting stage together and time them due to the geometry of said cutter profile. The meshing together and timing should take place by providing a specific distance of the cutting cylinders to each other. Especially the center to center distance is taken as reference. The second cutting stage can be located at a specific angle with regard to the first cutting stage or at a specific position. The position or specific angle can be dimensioned under the aspect that particles coming or falling out of the first cutting stage follow the cutting way into the second cutting stage. According to one embodiment of the invention the second cutting stage can be positioned below the first cutting stage or in a lower position in relation to the first cutting stage.

The second cutting stage includes a cutting cylinder which is called hereinafter the third cutting cylinder. Said third cutting cylinder of the second cutting stage can be meshed together and timed due to the geometry of the cutter profile with a specific distance to the matching cutting cylinder of the first cutting stage. With this matching cutting cylinder of the first cutting stage the third cutting cylinder forms the second cutting stage. This is one very simple and advantageous construction which incorporates three cutting cylinders forming two cutting stages for cutting flat material or paper twice.

It is possible to have a synchron gearing of the matching cutting cylinders. It is preferred to synchron gear the cutting cylinder of the first cutting stage forming a part of the second cutting stage to the third cutting cylinder of the second cutting stage. Such a synchron gearing can take place advantageously with a usual synchron gearing. As such it is possible to provide one single motor for the document shredder.

According to an alternative embodiment the second cutting stage can comprise another pair of cutting means or cutting cylinders. They also can be meshed together and timed as described above. Such a document shredder in one embodiment has four cutting means forming two cutting stages with two cutting means for each.

According to one embodiment of the invention guiding means can be provided for directing the particles being cut in a cutting stage and exiting said cutting stage. With such guiding means it is possible to guide the particles for example from the first cutting stage into the second cutting stage. Furthermore it is possible to guide the particles from the second or last cutting stage into a container for collecting and removing the particles out of the document shredder.

The guiding means can be formed in many ways. According to one possibility the guiding means are brushes or the like reaching into a cutting stage or cutting means such as cutting cylinders. According to another possibility the guiding means can be cams or cleaning strippers. Furthermore it is possible to provide a controlled airflow as guiding means. Such a controlled airflow can be produced with high pressurised air or ventilating means such as a fan or the like. An airflow has the advantage that it is contactless and as such is not underlying problems with wear or stress. In the scope of the invention it is possible to use a combination of different guiding means, for example cams and a controlled airflow.

The third cutting means of the second cutting stage can be designed as a cutting cylinder. This third cutting cylinder can advantageously be equipped with cams or cleaning strippers. The cams or cleaning strippers can be designed to provide an area for accommodating an airflow for the above mentioned combination of guiding means. In this case the airflow can be located behind such a cam or cleaning stripper. Advantageously, the airflow can pass several fixedly mounted guiding means.

Such a controlled airflow can be directed generally into the second cutting stage. Advantageously the airflow is introduced into said second cutting stage along the direction of at least part of the cutting way for the particles. As such the airflow can be a guiding and transportation means for particles exiting the first cutting stage to enter the second cutting stage. Furthermore it is possible to provide a position changing means for the particles exiting said first cutting stage and entering the second cutting stage. Such a position change has the advantage that for example longitudinally cut particles can enter into the second cutting stage in a direction differring substantially from their longitudinal direction. As such it is possible to cut a longitudinal strip into several shorter particles. With this detail it is possible to provide a much finer cutting of the particles and as such a higher quality of the document shredder.

In a preferred embodiment of the invention such position changing means provide an airflow or can be combined with an above described airflow as guiding means.

As cutting means of different cutting stages, namely the first and the second cutting stage, can be combined with each other and meshed together, they can form a kind of cleaning cams of the other cutting stage. This saves parts and simplifies the construction.

The size of the particles after exiting one of the cutting stages can be varied. In an especially preferred embodiment of the invention the size of particles exiting the first cutting stage is about 0.65 mm×7.5 mm or smaller. The size of particles exiting the second cutting stage can be about 0.65 mm×3 mm or smaller, especially down to 0.65 mm×0.65 mm.

A document shredder according to the invention can be equipped with such a two stage cutting system according to the invention. Furthermore it is possible with a cutting system according to the invention to equip an existing document shredder with only one cutting stage. According to a preferred embodiment a third cutting cylinder is mounted to the first cutting stage of the document shredder in such a way that it meshes together with one cutting cylinder of the first cutting stage. As such, it is clear that such a system for retro-fitting existing document shredders lies within the scope of the invention.

The cutting cylinders can be made up of a stack of cutting disks. They can be stacked together with cam disks or the like between two cutting disks. Alternatively, cutting cylinders can be solid cylinders. Such solid cutting cylinders can be equipped with separate cams or the like.

These and further features can be gathered from the claims, description and drawings and the individual features, both, singularly or in the form of sub-combinations, can be implemented in an embodiment of the invention and in other fields and can represent advantages constructions for which patent protection is hereby claimed.

Two embodiments of the invention are described hereinafter relative to the attached drawings, which show:

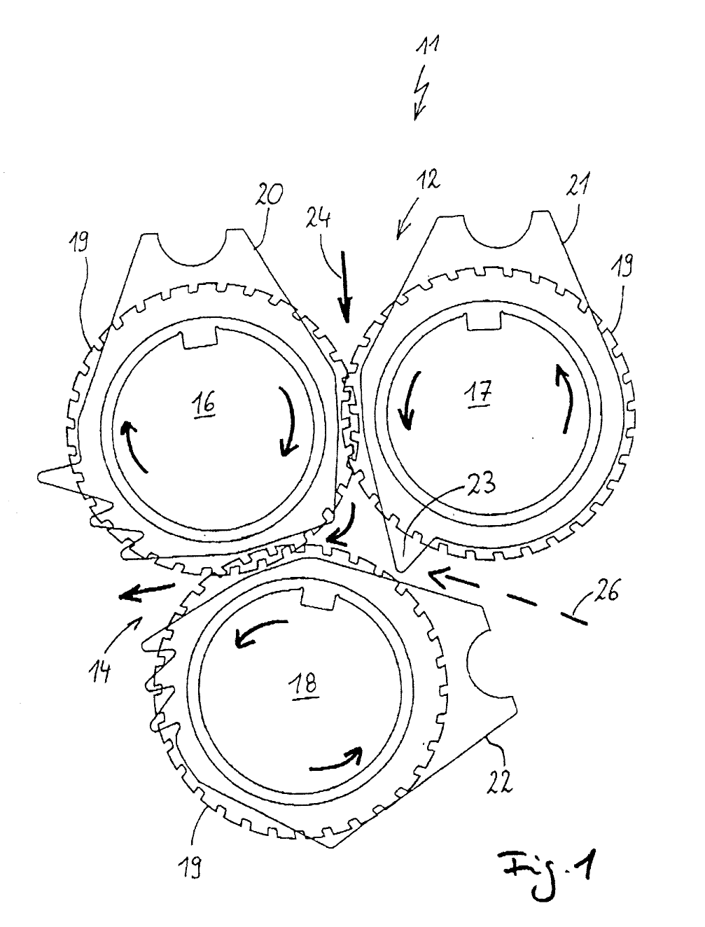

FIG. 1 a side view of a shredding system for a document shredder with three cutting cylinders forming two cutting stages and

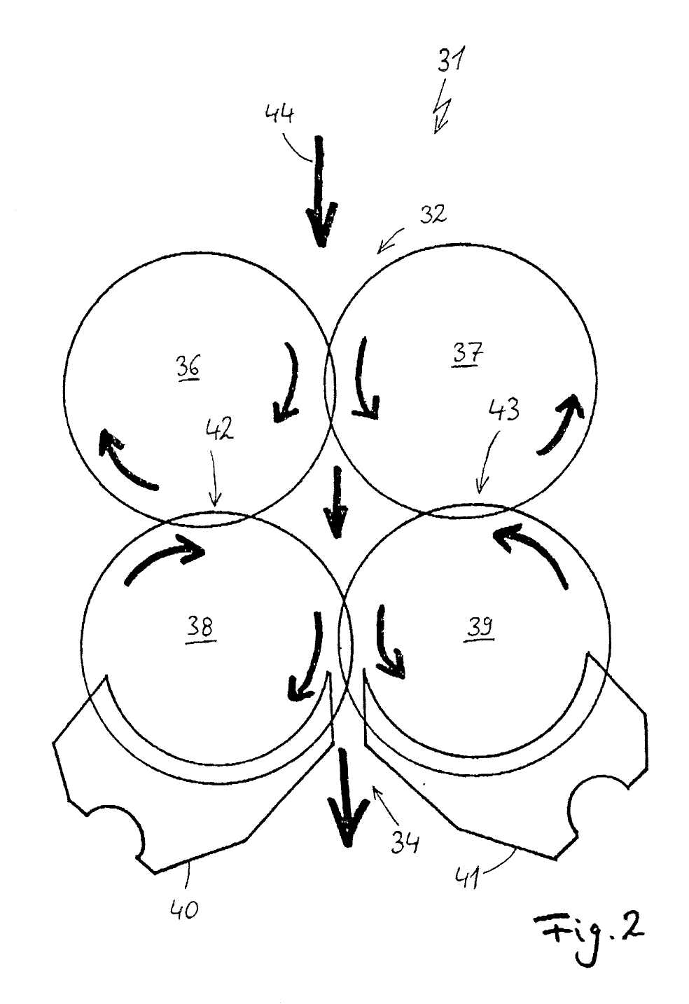

FIG. 2 a schematic side view of shredding system for a document shredder with four cutting cylinders forming two cutting stages.

In FIG. 1 a simplified embodiment of the invention is illustrated. A shredding system 11 is made up of a first cutting stage 12 and a second cutting stage 14. The expression cutting stage is to be understood mainly in a functional way meaning that in a cutting stage a cutting process is conducted.

The first cutting stage 12 is made up of a first cutting cylinder 16 in the upper left and a second cutting cylinder 17 in the upper right of the first cutting stage 12. The second cutting stage 14 is made up of the first cutting cylinder 16 and the third cutting cylinder 18. The third cutting cylinder is positioned underneath the cutting cylinders 16 and 17. It is positioned more to the left side of the first cutting cylinder 16 having some distance to the second cutting cylinder 17.

The cutting cylinders 16 to 18 are constructed according to a usual embodiment of cutting cylinders. That is cutting discs 19 and cams 20 to 22 are stacked together one onto the other to form a cutting cylinder. This is very common in the art and as such needs not to be described in further detail. As can be taken from FIG. 1, the cutting discs 19 of all three cutting cylinders 16 to 18 are identical. This facilitates the manufacturing of the cutting discs and as such of the shredding system 11 and lowers the costs.

All the while, the cams positioned between the cutting discs are different. The first cutting cylinder 16 has first cams 20, the second cutting cylinder 17 has second cams 21 and the third cutting cylinder 18 has third cams 22. The provision and design of such cams are to some extent common knowledge. For the invention disclosed in this application the design of the cams 20 to 22 is such that a cutting path 24 through the first cutting stage 12 and the second cutting stage 14 has four guiding areas made up of three cams. The cams 20 to 22 guide the cut particles from between the cutting discs 19 of the cutting cylinders out of the cutting cylinders or out of the cutting stage formed by the cutting cylinders. Namely the second cam 21 is provided with a nose 23 blocking the cutting path 24 after exiting the first cutting stage to the right side. This serves to guide cut particles after exiting the first cutting stage 12 by the third cutting cylinder 18 into the second cutting stage 14, namely between the cutting cylinders 16 and 18.

According to a further aspect of the invention an airflow 26 is provided, which is directed through the second and third cutting cylinders onto the entrance into the second cutting stage 14. It is aimed at the area where the first cutting cylinder 16 and the third cutting cylinder 18 mesh into each other for cutting. The airflow 26 can be produced in any convenient way. Preferably a fan unit or the like is implemented with nozzles or the like. The airflow 26 should reach all across the length of the cutting cylinders. The task of the airflow 26 is on one hand to guide or transport cut particles exiting the first cutting stage 12 into the second cutting stage 14. As such the airflow can be an additional guiding means along with the second cam 21 of the second cutting cylinder as well as the other two cams 20 and 22.

Another main task of said airflow 26 is to disturb the orientation and path of the cut particles exiting the first cutting stage 12. In some cases the particles cut in the first cutting stage 12 exit said cutting stage in a orderly and mainly parallel way, wherein the particles have the form of long strips. If these strips enter the second cutting stage in their parallel orientation they can somehow put themselves between the cutting discs 19 of the cutting cylinders 16 and 18 of the second cutting stage 14 so that no second cutting process takes place. This can be avoided by disturbing the orientation of the particles in such a way that they enter the second cutting stage disordered and/or with a certain angle. This angle can be somewhere between 0° and 90°, usually and shown from experience it is an angle between 40° and 70°. With this the long particles will be cut in some way across and in such reduced in length to a fraction of it. As a result the particles are cut to very small pieces rendering a high security shredding of documents.

The size of the particles after cutting in the first cutting stage and the second cutting stage can be determined by the geometry of the cutting discs 19. The smaller the size of the cut particles, the higher the security of the document shredder. The thickness of the cutting discs or the distance of the cutting discs to each other determine the width of the particles. The distance of cutting teeth of the cutting discs 19 to each other determine the length of the particles. For rendering a very high security shredder the cutting discs 19 can have a thickness of down to 0.5 to 0.65 mm. The distance of the teeth of the cutting discs can be about 5 to 10 mm. This gives a particle size after the second cutting stage of about 0.5-0.65 mm×0.65-3 mm. It is easily to be taken from this that such small particles make any reconstruction of the document shredded impossible.

Instead of the provision of the cams 20-22 other guiding means can be provided, such as brushes. Such guiding means need not necessarily be placed onto the cutting cylinder. They can as well be placed next to a cutting cylinder and reaching into the cutting cylinder with something like teeth or arms or the like.

From FIG. 1 can be seen that the use of the first cutting cylinder 16 being part of the first cutting stage 12 as well as the matching cutting cylinder for the third cutting cylinder 18 making up the second cutting stage 14 saves one cutting cylinder and thereby reducing cost and effort partly for about 25%. A synchron gearing of the cutting cylinders with each other is common knowledge and as such needs not to be described.

For retro-fitting existing shredders with the invention, respectively for adapting existing document shredders to have a shredding system according to the invention, it is possible to mount mainly only the third cutting cylinder 18 into the shredder. This can be done without problem if there is enough space. In some cases it is possible to use the basic document shredder but replace the existing cutting cylinders with cutting cylinders or a shredding system according to the invention. The third cutting cylinder 18, if mounted alone in combination with an existing document shredder has to be designed to fit together or to mesh with the matching existing cutting cylinder.

Another shredding system 31 is illustrated in FIG. 2. FIG. 2 is to be conceived as only a schematic illustration. The shredding system 31 is made up of a first cutting stage 32 and a second cutting stage 34. The first cutting stage 32 is the upper cutting stage being made up of a first cutting cylinder 36 and a second cutting cylinder 37. The two cutting cylinders 36 and 37 have an area where they reach into one another as is common for cutting cylinders in shredding systems.

Underneath the first cutting stage 32 is placed the second cutting stage 34 being made up of the third cutting cylinder 38 and the fourth cutting cylinder 39. These two cutting cylinders reach into one another as has been described for the first cutting stage. According to one aspect of the invention the cutting cylinders of the first stage reach into the cutting cylinders of the first cutting stage 32 for cleaning purposes, thereby replacing the need for cams or the like. The third cutting cylinder 38 reaches into the first cutting cylinder 36 in the first cleaning area 42 as can be taken from FIG. 1. In this way the third cutting cylinder 38 works as a cam for the first cutting cylinder 36. Cut particles of paper being held in the first cutting cylinder 36 are removed by the third cutting cylinder 38. As such, there is no need to provide cams or the like for the first cutting stage.

In the same way as has been described for cutting cylinders 36 and 38 the fourth cutting cylinder 39 reaches into the second cutting cylinder 37 in the second cleaning area 43. In this way the fourth cutting cylinder 39 works as a cam for the second cutting cylinder 37.

The cutting path 44 in FIG. 2 is in a straight direction into the first cutting stage 42 and from there down into the second cutting stage 44. Particles of cut flat material being stuck in one of the cutting cylinders 36 or 37 of the first cutting stage 32 will be removed by the cutting cylinders 38 and 39 of the cutting stage 34. This removal takes place in the cleaning areas 42 and 43. These particles as well will be transported into the second cutting stage 34 for the second cutting process. After exiting the second cutting stage 34 the cut material falls down into a container or the like for collecting.

As can be taken from FIG. 2 and becomes clear from the basic principles of shredding systems with cutting cylinders, the cutting cylinders 38 and 39 of the second cutting stage 34 are turning in the same sense as the cutting cylinders 36 and 37 of the first cutting stage 32. As such, the corresponding cylinders 36 and 38 as well as 37 and 39 reaching into each other for cleaning purposes are turning in opposite directions in the cleaning areas 42 and 43. This is not a problem for the construction illustrated in FIG. 2 and assists in the functioning of the cutting cylinders of the second cutting stage 44 for cleaning purposes.

There are provided cams 40 for cutting cylinder 38 and cams 41 for cutting cylinder 39. These cams 40 and 41 serve to clean the cutting cylinders of second cutting stage. These cams 40 and 41 can be constructed and fixed externally in a usual manner.

The cutting cylinders 16 to 18 in FIG. 1 have been described as being made up of stacked cutting disks 19 and cam disks 20 to 22. As an alternative the cutting cylinders in FIG. 2 are so called solid cutting cylinders. They are manufactured from solid steel cylinders. As such, the cams 40 and 41 have to be mounted and inserted afterwards and can cover no more than 180° of the circumference of a cutting cylinder.

Both versions of shredding systems 11 and 31 can be equipped with either stacked cutting cylinders or solid cutting cylinders. As the provision of cams is easier with the stacked cutting cylinders depicted in FIG. 1 they can advantageously be used with such a shredding system. On the other hand, as the cutting cylinders of the second cutting stage as depicted in FIG. 2 can replace cams or the like for the first cutting stage, solid cutting cylinders with independently mounted cams 40 and 41 are used in a shredding system according to FIG. 2.

The dimensions of the cutting cylinders in FIG. 1 and FIG. 2 can be the same regarding thickness of the cutting cylinders as well as width of the cut flat material corresponding to the thickness a cutting disc 19. In both versions the cutting cylinders are made up of special steel commonly used for such cutting cylinders.

In the schematic illustration in FIG. 2 there have been left out the details of the cutting cylinders having cutting teeth or the like as can be taken from the cutting discs 19 depicted in FIG. 1. Guiding means or the like for guiding cut flat material exiting the first cutting stage 32 and entering the second cutting stage 34 are not provided separately. In FIG. 2 the cutting cylinders of the second cutting stage fulfil this task. From FIG. 2 it can be easily taken that there is no exit from the inner space between the four cutting cylinders than through the second cutting stage 44. All the while an airflow corresponding to the airflow 26 in FIG. 1 can be provided. Such airflow should correspond to the cutting path 44. Furthermore, such an airflow can be used to disturb the position of the paper strips after exiting the first cutting stage.

1. Document shredder for cutting flat material into small particles with cutting means, said cutting means forming cutting stages, wherein at least one of said cutting stages includes two of said cutting means, said cutting means providing a cutting way through said document shredder, wherein said flat material follows along said cutting way, wherein at least a first and a second of said cutting stages are provided.

2. Document shredder according to claim 1, wherein one of said cutting means of said first cutting stage is part of said second cutting stage.

3. Document shredder according to claim 1, wherein said cutting means are cutting cylinders with a cutter profile.

4. Document shredder according to claim 3, wherein said cutting cylinders of each of said cutting stages are meshed together and timed due to the geometry of said cutter profile with a specific distance of said cutting cylinders to each other.

5. Document shredder according to claim 1, wherein said second cutting stage is located at a specific angle to said first cutting stage, said specific angle being dimensioned for said particles to fall out of said first cutting stage into said second cutting stage.

6. Document shredder according to claim 1, wherein said second cutting stage is positioned below said first cutting stage.

7. Document shredder according to claim 3, wherein said second cutting stage comprises a third cutting cylinder, said third cutting cylinder being meshed together and timed due to the geometry of said cutter profile with a specific distance of said third cutting cylinder to one of said cutting cylinders of said first cutting stage.

8. Document shredder according to claim 7, wherein said third cutting cylinder is synchron geared to said cutting cylinder of said first cutting stage to form said second cutting stage.

9. Document shredder according to claim 3, wherein said second cutting stage comprises two of said cutting cylinders being meshed together and timed due to the geometry of said cutter profile with a specific distance of said cutting cylinders to each other.

10. Document shredder according to claim 1, wherein guiding means are provided for directing said particles after exiting out of one of said cutting stages.

11. Document shredder according to claim 10, wherein said guiding means provide a guide from said first cutting stage to said second cutting stage.

12. Document shredder according to claim 10, wherein said guiding means are brushes.

13. Document shredder according to claim 10, wherein said guiding means are cams or cleaning strippers.

14. Document shredder according to claim 10, wherein said guiding means are designed for producing a controlled air flow.

15. Document shredder according to claim 13, wherein said cutting means of said second cutting stage are provided with said cams or said cleaning strippers.

16. Document shredder according to claim 15, wherein said cams or said cleaning strippers are designed to provide an area for accommodating a controlled air flow.

17. Document shredder according to claim 16, wherein said air flow is located behind said cams or cleaning strippers.

18. Document shredder according to claim 16, wherein said controlled air flow is introduced into said second cutting stage.

19. Document shredder according to claim 16, wherein said air flow is designed to provide a position change of said particles when exiting said first cutting stage and entering said second cutting stage.

20. Document shredder according to claim 1, wherein said cutting means of said second cutting stage are designed to be cleaning cams of said cutting means of said first cutting stage.

21. Document shredder according to claim 1, wherein the size of said particles after exiting said first cutting stage is about 0.65 mm×7.5 mm.

22. Document shredder according to claim 1, wherein the size of said particles after exiting said second cutting stage is about 0.65mm×0.65mm-3 mm.

23. Document shredder according to claim 1, wherein said second cutting stage is designed for a retro-fit to existing document shredders.

24. Document shredder according to claim 3, wherein said cutting cylinders are made up of stacked cutting disks.

25. Document shredder according to claim 24, wherein between said cutting disks are provided cam disks.

26. Document shredder according to claim 3, wherein said cutting cylinders are solid cutting cylinders being provided with separate cams.
